(19) United States
(12) Patent Application Publication
(10) Pub. No.: US 2007/0163699 A1
(43) Pub. Date: Jul. 19, 2007

(54) Process and device for processing a film web

(76) Inventors: Peter Wellenhofer, Grassau (DE); Heinz Lind, Mondsee (AT); Jurgen Breil, Siegsdorf (DE); Maximilian Standl, Tittmoning (DE)

Correspondence Address: NIXON & VANDERHYE, PC, 901 NORTH GLEBE ROAD, 11TH FLOOR, ARLINGTON, VA, 22203, US

(21) Appl. No.: 11/547,168

(22) PCT Filed: Feb. 3, 2005
(86) PCT No.: PCT/EP05/01088

§ 371 Date: Oct. 2, 2006

(30) Foreign Application Priority Data
Apr. 1, 2004 (DE) 10 2004 016 217.4

(51) Int. Cl. B32B 38/04; B32B 37/12; B26D 7/14; B26D 7/06; B31C 1/00; H01F 41/12; B29C 65/00; B31F 1/00

(52) U.S. Cl. 156/184; 156/229; 156/250; 156/259; 156/267; 156/185; 156/510; 156/543; 156/494; 156/578; 156/465; 83/27; 83/175; 83/18

(57) ABSTRACT

In an improved process for processing a film web, the film web is cut in the longitudinal direction, forming a marginal strip and a remaining film web with a width reduced by the width of the marginal strip. The marginal strip is transferred to a movable film-drafting device on which is arranged a gripper. The remaining film web is separated entirely or partially by cutting and also possibly by tearing. The film-drafting device is moved along one side of a roller arrangement, threading the film web into the roller arrangement. The film-drafting device is moved along one side of a winding device comprising at least one winding roller up to a release or end position. The film-drafting device is opened at the end position to release the marginal strip.

### INTRODUCTION

The invention relates to a process and a device for processing a film web.

The invention is based on uni-axial or bi-axial film stretching apparatus, as is known from the prior art (W096/29190 for example).

After uni-axial or bi-axial stretching has been carried out, the film produced accordingly in the known way is taken through various processing and test stations of a roller arrangement (so-called pull roll) and wound on a winding roller. Usually the film web is pulled manually by an operator into pull and winding rollers of film stretching apparatus by means of a so-called open drafting slot. In this case the film runs through alternately looped rolls and parts of machine stands must be encompassed. Thus, on the one hand the pulling speed is limited due to the physiological features of the operator, and on the other hand the costs of the complex design with an open drafting slot (so-called C pillar design) are substantially increased.

The aforementioned C-pillar design concerns a construction principle, wherein the rollers are supported alternately top and bottom. A corresponding system with a so-called C-pillar design according to the prior art is shown in schematic cross sectional representation on FIG. 18B with the C-pillars 2b on one side of the roller arrangement. Thus, along this side of the C pillars an accessible path for an operator is created, in order to allow the leading end of a film to be introduced into the arrangement via a drafting slot E shown in cross-section on FIG. 18B. Here this drafting slot E is formed in a safety grille, which is additionally necessary, in order to protect the operator from the mechanically moving parts, in particular the rotating rolls.

The film threaded in at one side on the so-called operator side on the pull roll is conveyed in full width through the pull roll and afterwards wound on an empty winding reel or winding roller with waste film in the so-called scrap position of the winding device. Only if the film has been stretched wide without creases and the corresponding quality criteria are met, does final rolling take place on a winding roller provided for further processing.

### DESCRIPTION OF THE PRIOR ART

The manual introduction of the film web with devices known from the prior art has the aforementioned disadvantages, especially as the operator requires a certain time to pull the film through the roller arrangement, as a result of which the down-time of the entire system continues to increase on start up or after a film tear.

Furthermore, the transfer process from the wide stretching machine to the pull roll and from the pull roll to the winding roller is a speed limiting and above all safety relevant element of the start up process.

Furthermore, a narrow drafting slot must be provided, which again leads to complex construction of the roller stands with which the rollers of the pull roll are supported.

From the prior art solutions are known, which however are based partially on other engineering principles or however also concern the processing of other materials such as paper webs for example.

European Patent EP 0 425 741 A1 describes a paper feeding device, wherein the paper to be fed is introduced via an adaptor consisting of synthetic material into a roller arrangement.

German Patent DE 21 54 119 concerns a process and a device for handling film webs, wherein a film strip is cut, which is conveyed via a pneumatic conveyor system to a winding device.

European Patent EP 0 427 234 B1 shows a device and a process for threading a film into a bi-axial stretching apparatus, wherein marginal strips are cut, which are transferred to grippers.

German Patent DE 20 21 246 discloses a device for feeding paper webs into rotary printing presses, wherein the start of the paper web is conveyed by a motorised carriage, which runs on a rail structure.

Fast and overall safe execution of the start up process for film stretching apparatus cannot be ensured by the patents described above and by the prior art.

The object of the invention is to provide a process and a device for processing a film web with which the down-times when starting up an entire stretching system are shortened and after occurrence of a film tear for example. Furthermore, it is an object of the invention to create a device for producing a film web wound on a roller, which is more simply designed compared to the prior art.

The object is achieved according to the invention by the independent patent claims. Preferred arrangements and refinements of the invention are indicated in the dependent claims.

### DESCRIPTION OF THE ADVANTAGES

As a result of the invention a number of advantages compared to the conventional solutions can be achieved. The most important advantages in this case are:

in the context of the invention shortening of the start up process and thus the down-times is possible. Furthermore, in the context of the invention safe start-up is possible and thereby overall safer operation of the film stretching apparatus;

with the invention the susceptibility to faults is also reduced overall;

by decreasing the down-times overall higher operating speeds are to be achieved, since in the context of the invention for the first time drafting rates of over 180 m per minute are also possible, whereby over the long term the output rates in turn are also substantially increased;

safety for the operator of the film stretching apparatus in particular when starting up the plant is clearly improved;

on the so-called control side of the pull roll and the reel contact roller stand, as a result of the invention similar construction as on the drive side can be implemented, since the so-called C-pillar construction according to the prior art can be dispensed with. Thus, the costs of the installation are reduced.

The invention thereby offers changes resulting in several advantages, which particularly as a result of their interaction lead to crucial improvements.

The film web is first cut according to the invention in the longitudinal direction, forming a marginal strip and a film web reduced by the marginal strip, which in the following is designated main film web. The marginal strip preferably has a width of approximately 5 to 10% of the total width of the film web, in particular at least 100 to 200 mm. The marginal strip and the main film web are separated in the transversal direction at certain times from their respective leader web. The separation process of the respective leader webs from the following film web in this case can already be started before the marginal strip is transferred to the gripper and conveyor device and completed after the transfer.

The longitudinal cutting of the marginal strip and/or the transversal cutting of the main film web take place preferably automatically with a movable cutting device. Alternatively however this can also take place manually or semi-manually. In practice for this purpose transversal cutting is possibly not necessary over the full working width of the main film web. Frequently it is sufficient if the main film web is only cut over its partial width, since the film then tears under tension in the transversal direction.

Preferably, the cutting device is arranged in the device according to the invention in the exit region of the stretching apparatus.

So that the cutting device can cut the marginal strip longitudinally, and also the main film web transversally, the cutting device can preferably be rotated about a vertically aligned pivot axis. The cutting tool preferably comprises a rotary blade, which can be driven by an integrated motor for example.

Furthermore, the cutting device in a preferred embodiment contains a so-called fixing arrangement, which prevents further tearing of the film web during the cutting operation. The fixing arrangement is preferably arranged along the pivot axis of the cutting device and preferably comprises fixing rollers, above and below the film. In this case the fixing rollers are arranged leading in the cutting direction of the film web before the cutting device, so that during the cutting operation no uncontrolled tearing can occur beyond the fixing rollers. As a result the fixing rollers are arranged in direct proximity to the cutting tool.

The cutting device for the transversal cutting of the main film web is movable, preferably at a pre-selectable angle to the pull direction of the film web over the working width of the film web, preferably in the exit of the stretching apparatus.

In a further embodiment of the invention the cutting device can be positioned so that the main film web can be transversally cut after the marginal strip has been longitudinally cut, in several variants:

the main film web is only transversally cut over its partial width and the film then tears completely under tension in the transversal direction. For this purpose it is possibly necessary to disengage the fixing rollers.

the main film web is transversally cut up to near the film edge on the drive side. In order to avoid collision with the clips leaving the stretching apparatus, the cutting device again pivots, and cuts a second longitudinal strip along the drive side. After the second marginal strip has run out from the stretching apparatus it is separated manually by the operator using a second transversal cutter.

alternatively to the possibility described above the film can also be cut over its entire width, that is to say especially if the cutting operation is synchronized with the clip movement in such a way that the film web is completely separated between two sequential clips.

the cutting device is moved in the forward direction of the film to a position, where the film has already been clipped out. For this purpose the cutting device is moved behind the opposite-lying chain rail. The transversal cutter therefore completely separates the main film web. The second longitudinal cut is thus omitted.

Subsequently, the marginal strip is transferred to a gripper and conveyor device.

Here the transfer can take place manually, semi-automatically or preferably fully automatically.

In the simplest case the operator transfers the marginal strip and feeds it manually into said gripper and conveyor device.

With semi-automatic transfer for example the film web can be taken up close to the reverse roller of the handling device or stretching apparatus and removed from the danger area. Only afterwards is the marginal strip preferably cut longitudinally and the main film web cut transversally. Then the operator can transfer the edge of the cut and feed it into the gripper of the gripper and conveyor device, so that the carriage of the gripper and conveyor device can move away and thread the film web into the following pull roll device.

The transfer device mentioned in this case preferably consists of a clamping and/or suction device to guide the film web in a substantially horizontal direction. With a preferred embodiment of the invention a conveyor (so-called belt feeder) or for example a vacuum table or the like can be used, which can be raised by an elevating and lowering device, for example in the form of a scissor jack, up to the film plane. After the carriage, provided with a gripper, of the gripper and conveyor device has moved away to thread the film web, the conveyor belt in the form of the so-called “belt feeder” for example is then again lowered.

In addition however the film web, cut accordingly, can be transferred to the gripper and conveyor device fully automatically.

In this preferred fully automatic embodiment of the invention a gripper and conveyor device, which is part of a film-drafting device, proceeds to transfer the marginal strip up to the exit region of the stretching apparatus and then automatically grips the marginal strip. As a result the marginal strip can be transferred automatically to the film-drafting device. During the transfer of the marginal strip preferably the marginal strip is also cut transversally.

The film-drafting device as mentioned comprises a movable gripper and conveyor device, consisting of an integrated gripper and/or clamping device for the film edge, a driving device and a transport rail. The clamped film moves a pre-determined distance along one side of the roller arrangement and threads the film web into the roller arrangement.

The driving device preferably comprises an electrically and/or mechanically driven carriage with one or several driving rollers, which can be moved on a belt-like guide rail extending from the exit region of the stretching apparatus along one side of the rolling arrangement and one side of the winding device.

The power for the drive unit can preferably be supplied by accumulators or by a current rail arranged alongside the guide rail. One or several of the driving rollers is provided with a surface coating having a high coefficient of friction, in order to permit good frictional engagement with the guide rail. In addition the carriage can comprise a hugger device, with which the driving rollers are pressed against the guide rail.

Finally, the film is conveyed on the winder up to an end position, where the gripper on the conveyor device releases the marginal strip, so that the film web is then wound on a winding device after previous application of adhesive means on the film.

The gripper and conveyor device can be moved to and fro alternating between the transfer point and the release position to wind the film on a winding stand for example. Alternatively a closed circulating rail arrangement is also possible.

In a further advantageous arrangement of the invention a section of the guide rail is preferably controlled automatically in a region along one side of the winding device, by moving or pivoting for example.

Furthermore, in the device according to the invention an opening device can be arranged in the end position of the film-drafting device to open the gripper of the gripper and conveyor device. The opening device here is preferably an opening wedge.

A device can also be provided in the vicinity of the winding device, which can apply adhesive means onto the film web. The device mentioned is preferably coupled with a detector or sensor facility, with which it can be recognized whether a film web is at any place in the winding device.

### DESCRIPTION OF THE DRAWINGS

Embodiments of the invention are described below on the basis of the appended drawings, wherein are shown:

FIG. 1: a side view on the exit of a film stretching apparatus with following pull rolls and a further following winding station with a film-drafting device provided according to the invention;

FIG. 2: a plan view onto the film web running from a stretching apparatus for elucidation of the cutting operation in accordance with an embodiment of the invention;

FIG. 3: a side view of a cutting device as used in connection with the invention;

FIG. 4: a plan view onto the film web running from a stretching apparatus to elucidate the cutting operation in accordance with a further embodiment of the invention;

FIG. 5: a plan view onto the film web running from a stretching apparatus to elucidate the cutting operation in accordance with an alternative embodiment of the invention;

FIG. 6: a part view, which shows the transfer operation of the marginal strip of the film web to the film-drafting device in accordance with an embodiment of the invention;

FIG. 7: a perspective view of an inventive embodiment of a gripper and conveyor device to convey a marginal strip of the film web;

FIG. 8: a further perspective view of the gripper and conveyor device according to the invention;

FIG. 9: a sectional view through the gripper and conveyor device and the guide rail on FIG. 7 along a plane perpendicular to the rail track, the gripper of the film-drafting device not being illustrated;

FIG. 10: a perspective view of the gripper and conveyor device from FIG. 7 along a plane perpendicular to the rail track, the gripper of the film-drafting device also being illustrated;

FIG. 11: a perspective view of the hugger device integrated in the gripper and conveyor device on FIG. 7;

FIG. 12A: a perspective view of a guide rail used in the inventive process;

FIG. 12B: a cross sectional illustration through the guide rail shown on FIG. 12A;

FIGS. 13A and 13B: two winding devices in side view as they are known in principle from the prior art, in connection with two alternative arrangements of the end region of the film-drafting device;

FIG. 14: a partially sectional view along plane I-I of FIG. 13A for elucidation of the pivotable guide rail in accordance with an embodiment of the invention;

FIG. 14A: a partially enlarged reproduction of the pivotable rail section shown on FIG. 14;

FIGS. 15A to 15E: schematic side views of the winding device for elucidation of the movement- and operational sequence in accordance with an embodiment of the present invention;

FIGS. 16A and 16B: plan views onto part of the film web within a region, where in accordance with two alternative embodiments of the invention adhesive means are applied to the film web;

FIG. 17: a detailed view of the film-drafting device in the vicinity of the end position for the gripper and conveyor device;

FIG. 18A: a cross sectional view through a pull roll deviating from the prior art;

FIG. 18B: a cross sectional view through a pull roll according to the prior art;

FIG. 19A: a side view of a first exemplary embodiment of a semi-automatic transfer device in side view with the belt pull device raised (belt feeder);

FIG. 19B: a partial plan view onto the embodiment corresponding to FIG. 18A on the operator side of the plant;

FIG. 20A: an illustration corresponding to FIG. 19A, with “belt feeder” again lowered; and

FIG. 20B: a plan view corresponding to FIG. 19B during the film production with “belt feeder” lowered.

### DETAILED DESCRIPTION OF DRAWINGS

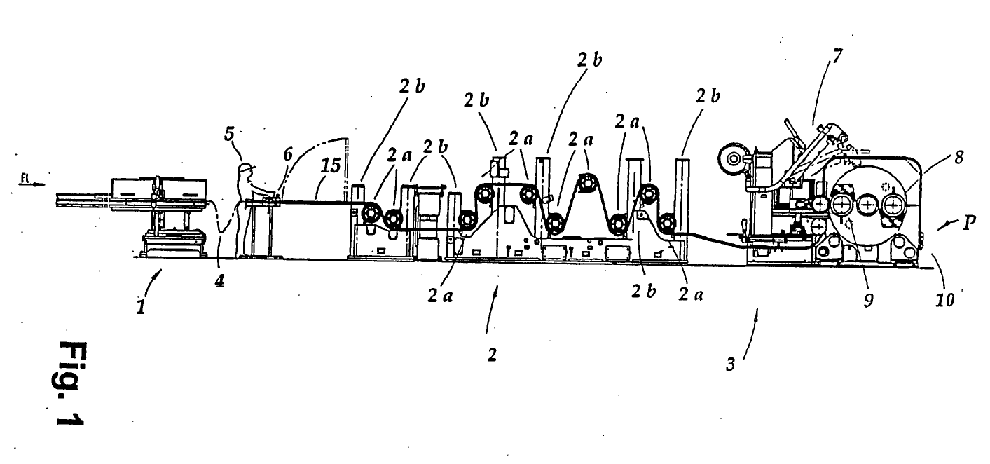

FIG. 1 shows in the side view the exit of a film stretching apparatus, the pull roll with different process and test stations and the winding stand in accordance with an embodiment of the invention. The film web 4 is illustrated as a meandering solid line.

Originating from the exit of the stretching apparatus 1 the film 4 is taken through the pull roll 2 with a plurality of rollers 2a and roller stands 2b. After the film 4 has run through the pull roll 2, it is fed onto a winding device 3, wherein the film 4, after adhesive means are applied, is wound on a so-called scrap winding roller 8.

The film is rolled onto the scrap roller until the film is straight over the entire working width, and meets the desired quality criteria.

Subsequently the film is wound onto the winding roller 9 after being cut with the transversal cutter 7 (reverse winding operation).

For transferring the film to a film-drafting device a marginal strip is cut by means of a cutting device 11 located within the exit region of the stretching apparatus 1 (not obvious from FIG. 1), said strip is taken by the operator 5 and inserted into a gripper and conveyor device 10 of a film-drafting device, if this is located between the stretching apparatus 1 and the winding arrangement 2. The gripper and conveyor device in this case is movable along one side of the roller arrangement and the winding device on a meandering guide rail 15 and can be moved back again from its end position P via the guide rail to the operator 5. The meandering guide rail 15 evident on FIG. 1 as a side view in this case defines a path, which corresponds to the path of the film web through the plurality of rollers belonging to the roller arrangement 2 and leads up to the winding device, in order—which will be explained later—here to transfer a leading end of the film web to the winding device.

After the operator has fed the film marginal strip into the film-drafting device 10, he can cut off the front part of the film marginal strip, protruding from the film-drafting device, by means of a cutting unit 6. In the embodiment shown on FIG. 1 after cutting the marginal strip, the main film web following the marginal strip is manually cut off by the operator and/or by a plurality of operators 5. Sometimes a small cut is already sufficient, as a result of which, starting at the cut, the remainder of the film web tears off itself under the existing tension.

Finally, the gripper and conveyor device moves along the guide rail and via the marginal strip draws the film web into the rollers 2a of the roller arrangement 2. The structure of the film-drafting device, which comprises grab equipment for taking hold of the film web or the marginal strip and can be moved in the nature of a carriage on the guide rail 15, will be described later in greater detail. Said rollers 2a are driven in the known way by a driving device, which is provided on the side of the roller arrangement lying opposite the guide rail 15.

As a result of the cutting of a marginal strip mentioned a transport cord for the film web, with which the same can be threaded into the roller arrangement, is thus formed. The guide rail here is arranged between the roller stands and the rolls of the roller arrangement, for which reason—in contrast to the prior art—a complicated pillar construction on the feed side of the roller arrangement can be dispensed with.

After the film-drafting device has passed through the roller arrangement, it moves further into the winding device 3, where it is first taken past the winding rollers 8 and 9. Finally the film-drafting device reaches the park position P, where the film marginal strip is released and laid on the scrap winding roller 8. Adhesive means are applied in a suitable place, so that the leading end of the film is held on the scrap roller. Finally the film web is wound onto the scrap winding roller 8.

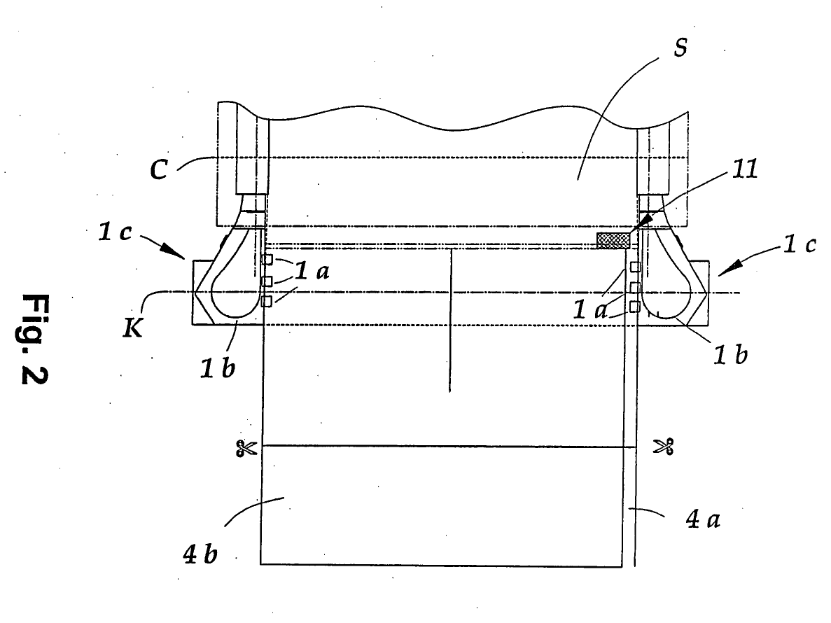

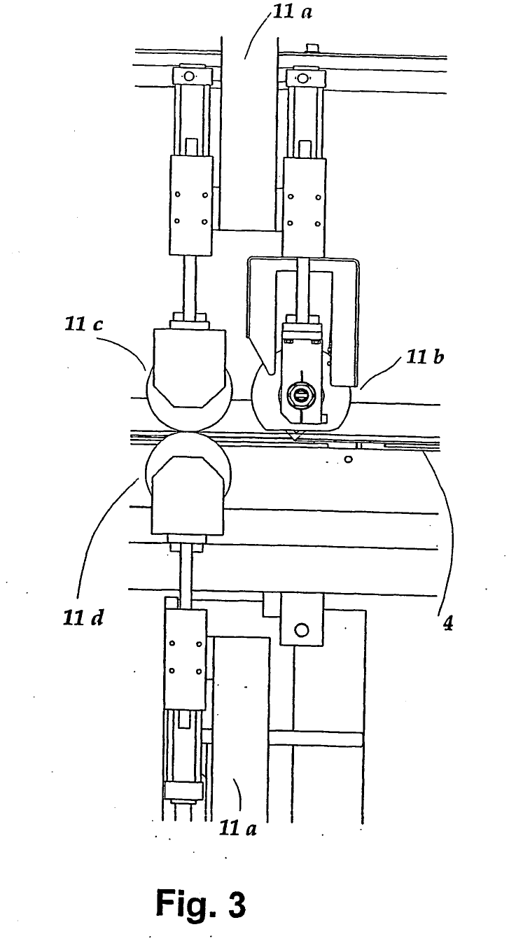

In the following, with reference to FIGS. 2 and 3 the cutting operation according to the invention is explained as regards the film web 4 and a possible embodiment of the associated cutting device.

FIG. 2 in this case shows a plan view onto the film web 4 in the exit region of the stretching apparatus 1. In the stretching apparatus 1 the film web 4 is conveyed in the known way via so-called clips 1a, some of which are indicated schematically on FIG. 2. The end of the cooling zone is demonstrated on FIG. 2 by the line C. Furthermore on FIG. 2 the so-called clip-out line is highlighted by the line K, where the clips 1a are opened and the edges of the film web 4 are released.

In the exit region a rectangular safety area S indicated by dotted lines is formed overall, which is not accessible to the operator. The cutting device 11, which is only schematically indicated and described in detail below, is located in this safety area. The cutting device is arranged on the operator side and in a region of the stretching apparatus 1, where the film web is still held with the clips 1a. As a result the tension necessary for cutting the film is maintained. From FIG. 2 it is clear that the cutting device 11 cuts the film web on the operator side, forming a marginal strip 4a as well as a main film web 4b. The marginal strip 4a in the embodiment shown on FIG. 2 is fed by the operator into the film-drafting device 10, and afterwards the main film web 4b is separated and a leader web 4′b is manually cut off from the main film web together with a front end of the marginal strip by the operator. This is indicated on FIG. 2 by two scissors. Finally the marginal strip is conveyed by means of the gripper and conveyor device, as a result of which the film web is fed into the pull rolls and the winding device.

FIG. 3 shows a detailed side view according to the invention of the cutting and fixing unit used in an embodiment of the inventive process. The cutting device here is mounted on a pivot axis 11a, wherein in the side illustration on FIG. 3 an adjustable cutter blade 11b is located to the right of the pivot axis and adjustable fixing rollers 11c and 11d are fitted to the left of the pivot axis. The cutting device with its cutter blade and fixing unit is movable over the entire width at a rake angle.

In this case the cutter blade is rotatable about the pivot axis 11a, so that the cutter blade is aligned at an angle to the pull direction of the film web. The adjustment takes place in such a manner that, related to the film pull speed and the feed rate of the cutter blades, a suitably correct angular adjustment is made, in order to produce a correspondingly pre-selectable cut through the film. Furthermore so-called fixing rollers 11c and 11d are provided, which likewise in common with the cutting device are held and aligned via the pivot axis. The fixing rollers 11c and 11d rotate freely or are driven by motors.

The rollers pressing above and below the film prevent tear propagation on the film.

A further improved process, modified in relation to FIG. 2, for cutting a leading remaining film section of a following film web to be finally wound up is explained with reference to FIG. 4. In this case FIG. 4 shows a plan view onto the film web 4 in the exit region of the handling device 1, the film in this arrangement of the invention being automatically cut by the cutting device 11. First, as explained with reference to FIG. 2, a marginal strip 4a, which is fed into the gripper arrangement on said film-drafting device 10, is cut by the cutting device 11. After the film edge has been inserted, the front end of the edge can be cut off, as indicated in position P1 on FIG. 4. Furthermore FIG. 4 shows the gripper and conveyor device 10 in the position, where the film marginal strip is inserted. After an edge has been cut by the cutting device 11, the cutting device moves transversally to the longitudinal direction of the main film web from the operator side towards the drive side. This is indicated by a corresponding arrow 11′ on FIG. 4 and corresponding instantaneous snapshots of the position of the cutting device 11 while moving. The cutter blade of the cutting device here is aligned transversally to the direction of the film web, forming a bevelled edge Q. After the cutting device 11 has reached the left hand side of the film web, the cutter blade again turns in a direction parallel with the longitudinal direction of the film web and a second edge 4c is cut. The cutting of the second edge is necessary in the embodiment of FIG. 4, since the cutting device 11 cannot separate the left film edge, as due to its position inside the stretching apparatus (TDO) it would collide with the clips. However, it is also conceivable that the cutting device 11 is triggered in such a manner that it can move through two adjacent clips. In such a case cutting of the second edge 4c can be omitted.

The transfer, explained on the basis of FIG. 4, of a leading section 4′a of the film web 4 thus takes place in a leading film edge section 4′a, which is formed by the previously cut marginal strip 4a and the film web section now becoming increasingly wider by the moved cutting tool. In the schematic illustration on FIG. 4 the leading film edge section 4a is thus transferred and attached in the region of the film section 4′a at a point in time when the cutting device 11, already starting from the initial cutting position 11a on FIG. 4, lying on the right edge of the film web, is moved up to the position 11b lying further on the left shown on FIG. 4. In other words the cutting operation is normally first begun away from the film edge section lying on the right on FIG. 4 towards the opposite film side, wherein the leading film edge region 4′a, formed transversally in such a way is then fed into the film-drafting device 10, which can then move along the guide rail while the film web is threaded into the downstream roller arrangement.

Deviating from the illustration on FIG. 4 however, the film edge can be transferred to the film-drafting device for example also at a position P2, where only the marginal strip 4a is formed and has not yet mutated into the triangularly expanded film section 4′a. In this case the separation cut for separation of a further leading edge section of the marginal strip 4a would take place at P′2, so that the film-drafting device 10 can pull the following film web 4a into the roller arrangement via the marginal strips and the only later adjoining triangularly expanding film section 4′a.

The second marginal strip is finally cut off by a further blade element 12 on the left film edge, as indicated in the position P2. The blade element 12 can preferably also be moved in the transversal direction to the film web and if necessary can also perform the slitting of the film edge 4a on the right film edge, wherein the cutting device 11 in this case is only responsible for cutting the film web transversally. Through the operational sequence illustrated on FIG. 4, automatic cutting of a feed marginal strip and a canted main film is achieved. The marginal strip with the adjoining canted section can be easily threaded into the roller arrangement and the winding device by means of the film-drafting device, without requiring the manual assistance of an operator. As a result the time for setting up the system can be shortened and the susceptibility to faults of the system can be substantially reduced.

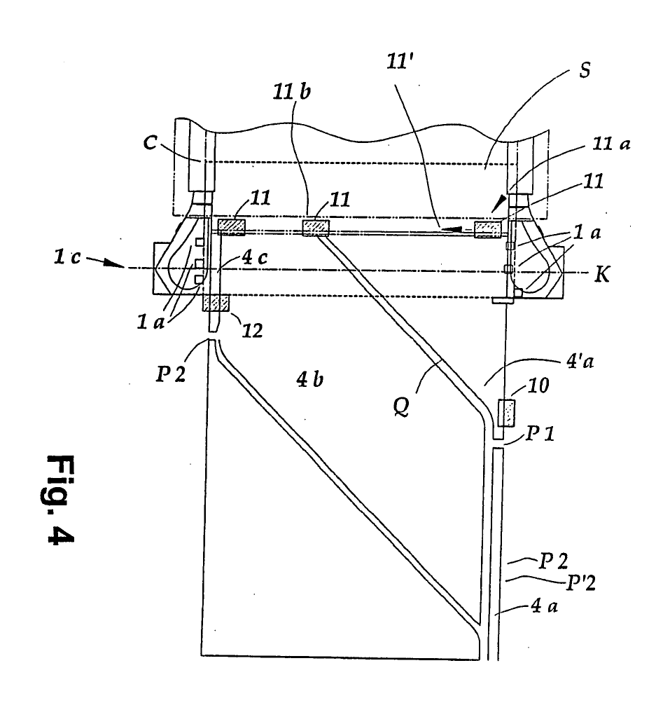

On the basis of FIG. 5 a cutting operation, again modified in relation to FIG. 4, is explained.

FIG. 5 in turn shows a plan view onto the film web 4 in the exit region of the stretching apparatus 1, illustrating a modification of the cutting operation on FIG. 4. According to this embodiment the film web is cut transversally by a process of the cutting device diagonally to the film web (as indicated by the arrow 11″), and to be precise in one direction, so that the cutting device 11, after moving, is located in a region beyond the clip-out line K. As a result the longitudinal cut of a second marginal strip 4c shown on FIG. 4 can be dispensed with, since the cutting device cannot collide with the clips and thus the remaining film web 4b can be separated completely.

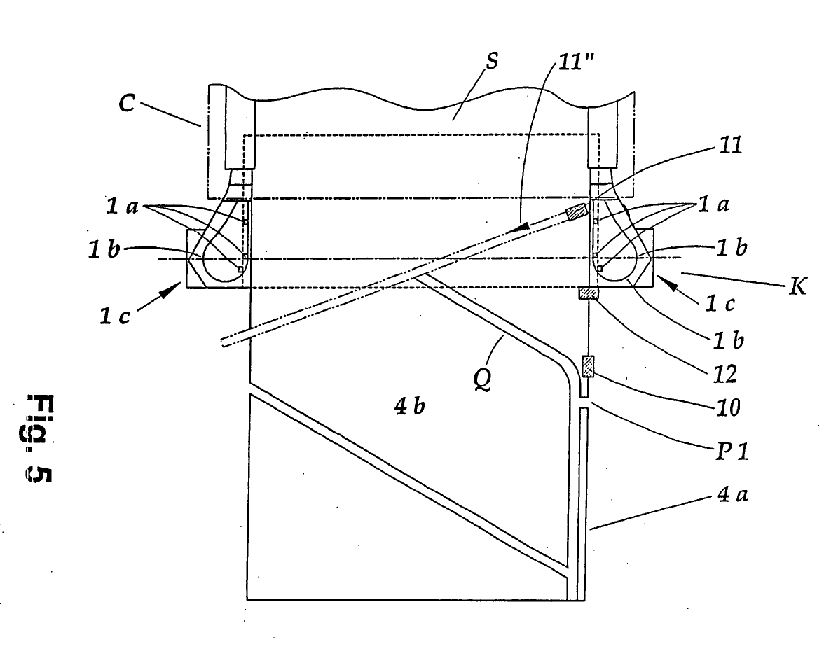

FIG. 6 shows a detailed view of the transversal cutting unit 6 of the marginal strip illustrated on FIG. 1. Here a scenario is illustrated, where the gripper and conveyor device 10 is located adjacent to the cutting unit 6. The film strip has already been fed by an operator into the gripper and conveyor equipment 10, wherein a closing device 13, only indicated schematically, which closes the gripper and conveyor device, can be provided. The closing device, in particular manual, can dispose of hydraulics, pneumatics or the like, in order to close the grippers of the gripper and conveyor device. The front section of the film strip can then be cut off by means of a blade element 14 provided on the cutting unit 6. Then the marginal strip is conveyed by the film-drafting device moving away.

Deviating from the manual transfer described above (which represents the simplest case), the transfer can also take place semi-automatically or fully automatically.

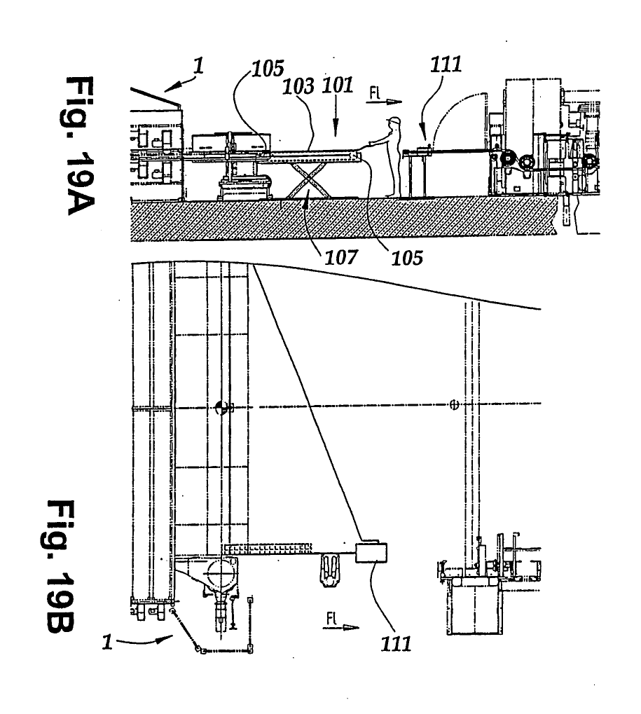

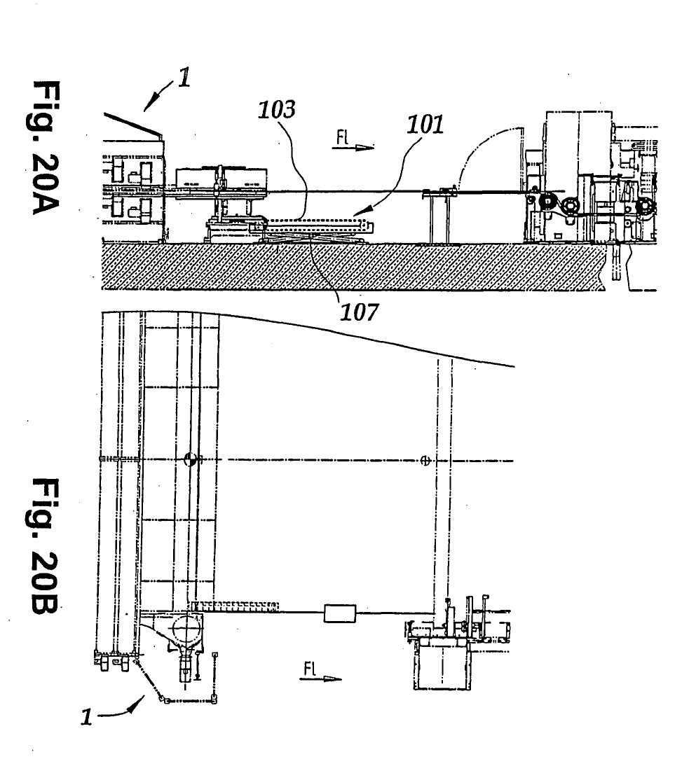

The semi-automatic transfer preferably takes place close to the reverse roller 1c of the handling device or stretching apparatus 1. Here the transfer for example can take place by a suction belt, a single belt located underneath the film, for example a double belt, which is arranged underneath and above the film, or however by other types of conveyor devices. In this case an exemplary embodiment for a semi-automatic transfer will be explained in greater detail on the basis of FIGS. 19A to 20B.

Here a section of the transfer device according to the invention is shown on FIG. 19A in a side view and on FIG. 19B in a plan view.

From this it is clear that for example a so-called belt feeder 101 is provided, which extends over the entire width of the film 4 or only over a sufficient partial width or in each case consists of several individual belt feeders 100, which each extend over a partial width and are arranged next to each other. These comprise a circulating belt 103, which can be driven between two reverse rollers 105. This belt feeder is height adjustable in the embodiment shown, wherein in the embodiment shown a scissor jack 107 is provided.

In operation this belt feeder is raised by the scissor lift 107 up to the film plane, in order then to remove the film 4, uncut at this stage, from the danger area. After the explained marginal strip cut and the traversal cut to be carried out in addition, an operator can then take hold of the cut face (that is to say the leading end of the film web), preferably on the leading edge section 4′a described or the leading film section 4′a located on the edge, in order to feed this film section into the gripper of the gripper and conveyor device. Afterwards the carriage, equipped with the gripper, of the film-drafting device can for example be controlled by a timer or started off by pressing a button etc, in order to thread the film web into the following pull roll. Subsequently the belt feeder is then again lowered into its lowered position shown on FIG. 20A. With this semi-automatic process therefore the operator shown in a side view on FIG. 19A must only take hold of the leading film end, perform a half swing movement to the right, in order then standing next to the side edge of the film web to feed the leading film web end 4′a or the leading edge section 4a into the gripper of the gripper and conveyor device. Here the carriage with the gripper is located at this stage in its initial position 111, as shown on FIGS. 19A and 19B.

The marginal strip can however also be transferred fully automatically, preferably close to the reverse roller 1c of the handling device or stretching apparatus. For this purpose the film-drafting device moves directly as far as the clip-out line K and takes up the marginal strip there. With semi-automatic or automatic transfer of the film the automatic transversal cut is synchronized with cutting off the front end of the marginal strip 4a.

The conveyance of the entire film web is facilitated and accelerated by the marginal strip and any danger of the film web blocking, which may occur when it is being drawn through the roller arrangement, is substantially reduced. Furthermore cutting of a marginal strip always provides the same start conditions and automated transfer of the film to the film-drafting device directly at the clip-out line of the handling device is possible.

The further structure of the gripper and conveyor device is explained below on the basis of FIGS. 7 to 11.

FIG. 7 shows a perspective view from below onto the gripper and conveyor device 10 used in accordance with the invention, wherein this can be moved on the guide rail 15. The gripper and conveyor device is designed as a movable carriage, which preferably has its own power supply 10b, driving corresponding transport rollers (not evident from FIG. 7), that contact one side of the guide rail 15. The device has a gripper 10a, having grab arms, which can be opened and closed by a corresponding mechanism and clamp the film margin strip. Various mechanisms to open and close the gripper located on the film-drafting device can be used, for example in the form of articulated lever arrangements, known for a long time from the prior art, or in the form of pneumatic, hydraulic and/or electrical devices and the like.

Furthermore, the gripper and conveyor device 10 comprises a hugger device 10f, which ensures frictional engagement of the drive rollers of the gripper and conveyor device with the guide rail 15. Such a hugger device likewise has been known for a long time from the prior art and in the embodiment on FIG. 7 is configured as a spring lever, wherein the spring lever is guided across four rollers 101 on one side of the guide rail 15. Furthermore, the guide rail itself is fastened via a plurality of holding devices 16 to one side of the roller arrangement or the winding arrangement.

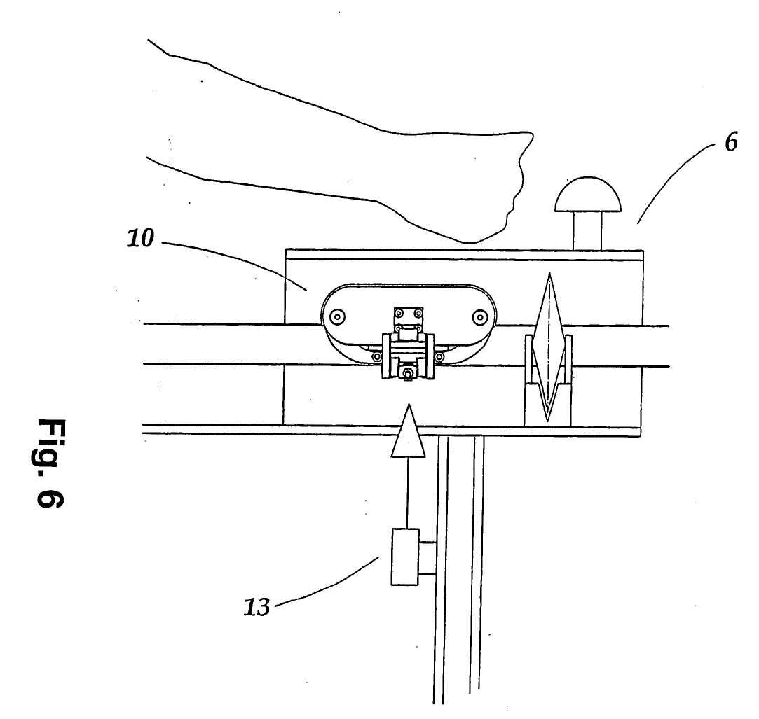

FIG. 8 shows a further perspective view from above onto the gripper and conveyor device 10 according to the invention, the guide rail not being illustrated. From FIG. 8 it is particularly evident that the gripper and conveyor device (illustrated here) has two transport rollers 10c and 10d, which are driven via the drive unit(s) 10b. One or several of the driving rollers are provided with a surface coating having a high coefficient of friction, in order to permit good frictional engagement with the guide rail.

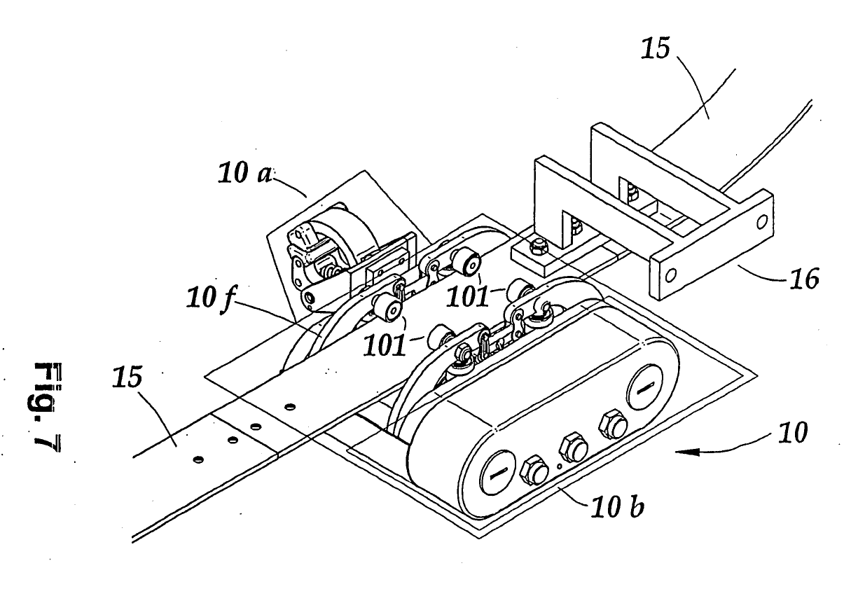

FIG. 9 shows a cutaway view of the movable gripper and conveyor device 10 on FIG. 7, and to be precise along a plane perpendicular to the guide rail in the region of the holding device 16. The drive is designed as a DC or AC motor and connected via planetary gears 10h. The motor is preferably driven via accumulators 10o. The power is correspondingly transmitted via the motor housing 10i, which is firmly connected by the frame housing 10j to a driving drum 10k on which a shaped part 10m is arranged. The driving drum 10k and the shaped part 10m form the transport roller 10c. The shaped part 10m ensures frictional engagement with the surface of the guide rail. The transport roller is mounted via ball bearings 101 or 10q. Furthermore ball bearings 10n as well as roller bearings 10p are provided, wherein the roller bearings support the rollers 101 illustrated on FIG. 7. The ball bearings 10n serve to laterally guide the carriage on the guide rail 15.

The driving device shown in FIGS. 7 to 9 has a series of advantages. In particular it has compact dimensions with good pull torque. This is very important in the present invention, since the drive device moves along small bend radii in a meandering guideway. An improved position of the centre of gravity with a decrease in tip-over torque is attained by the motor inside the driving device. Furthermore the transport rollers can be quickly adapted to the particular requirements by changing the surface lining or surface profile and quickly replaced. By adjusting the spring action of the hugger device the applied force is easy to adjust in the frictional engagement direction. Preferably a regulator is incorporated in the driving device, wherein different processes can be controlled. In particular starting, stopping, stable tensile force and torque can be adjusted.

In this case the speed of the movable carriage, that is to say of the gripper and conveyor device movable along the guide rail is correlated with the operating speed of the stretching apparatus and the roller speed at the pull roll, wherein the driving device for the film-drafting device is preferably adjusted so that tensile forces are always exerted on the film web via the gripped leading end of the film web being drawn in and by the drive of the rollers of the pull roll.

The guide rail is preferably manufactured using standard semi-finished products made from non rusting metal, so that functionality remains guaranteed under aggressive site conditions. The gripper of the film-drafting device has a large gripper opening and if necessary can be equipped with a self-activating mechanism in the event of overload.

FIG. 10 shows an example for a possible structure of a gripper 10a.

FIG. 10 shows a cutaway view of the grab equipment shown on FIG. 7. The cutaway view in particular represents a section through the transport roller 10d, so that the lining system with high coefficient of friction (here as an example O-rings 10e in the section) is evident. Furthermore, FIG. 10 shows the structure of the gripper 10a, which is designed in the nature of an articulated lever joint. In this respect reference is made to known articulated levers and their working principle. Such a gripper comprises an upper clip cheek 201 and a lower clip cheek 202, which hold the marginal strip 4a of the film web. The clip cheeks in each case are mounted rotatably on an upper cheek lever 203 or lower cheek lever 204. The cheek levers in turn are rotatably mounted on fulcrums 206 or 207. So that a defined clamping force is exerted on the marginal strips, an articulated lever 208 is pre-stressed by a spring (not shown). This spring operates here between the fulcrum 206 of the upper cheek lever and the fulcrum 207 of the lower cheek lever and can be preset with an adjustment screw. By applying force on the articulated lever 208 in the directions indicated by the arrows the gripper can be opened or closed. This can take place either manually with an operator or by means of a suitable opening and/or closing arrangement.

From FIG. 10 it is also evident that the plane of the film web coincides with the centre of the guide rail, so that as a result of the film tension the tip-over torque on the drive unit is reduced.

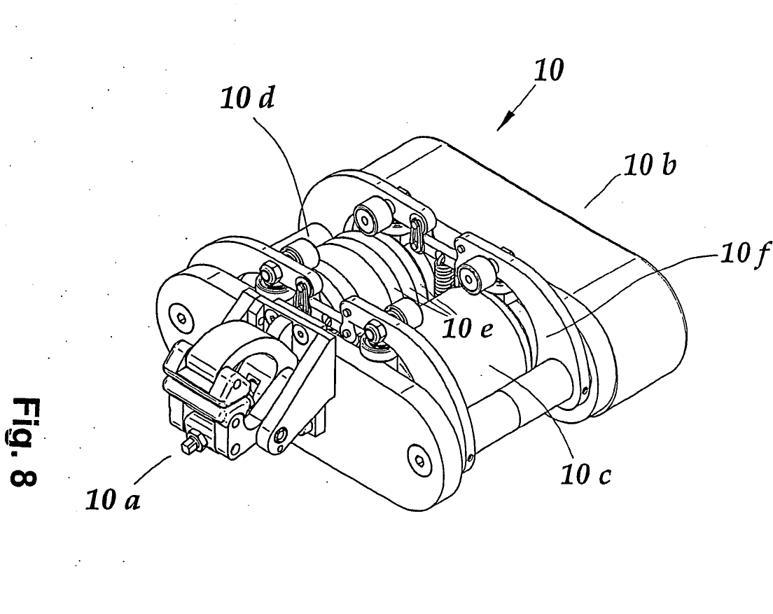

FIG. 11 shows a perspective view of the hugger device 10f used in the gripper and conveyor device 10. As a result of the hugger device positive or frictional engagement is compensated or maintained when the carriage is moved within circular bends of the guide rail. For this purpose the rollers 101 are used, which are clamped by means of a clockwork mechanism in the form of springs 102, in the direction of the transport rollers of the film-drafting device. The rollers 101 in each case are fixed to cranks 103, which in turn are fastened to bearing bushes 104. The cranks shown can carry out movements, independent of each other. The force is applied via a rocker 104, which is fastened to the cranks via chain links 105. Furthermore a spring tensioner 106 is located on the spring to adjust the tensile force.

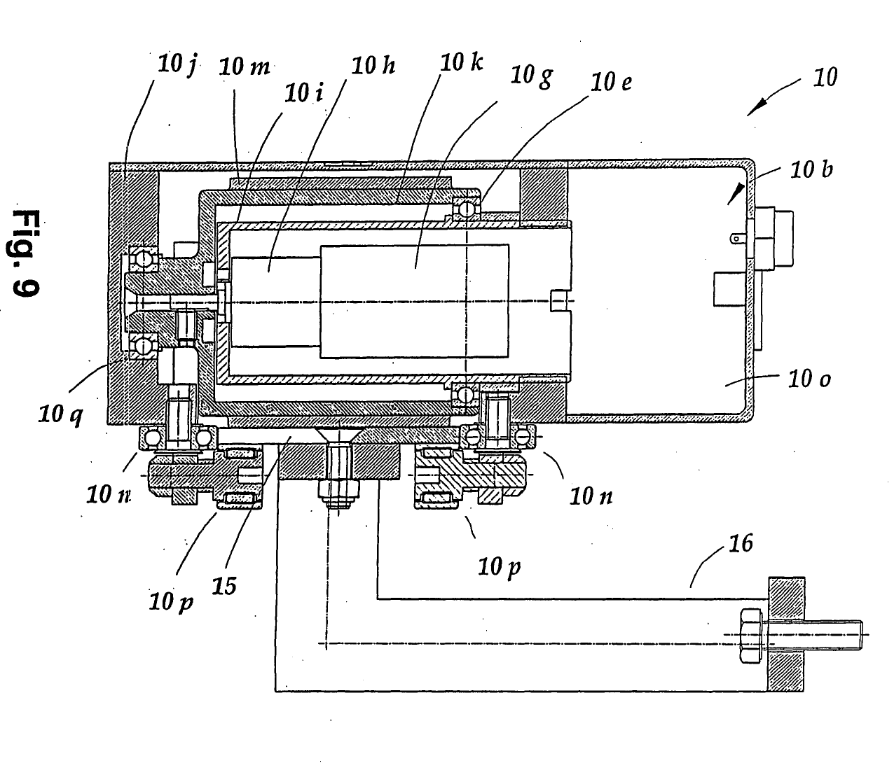

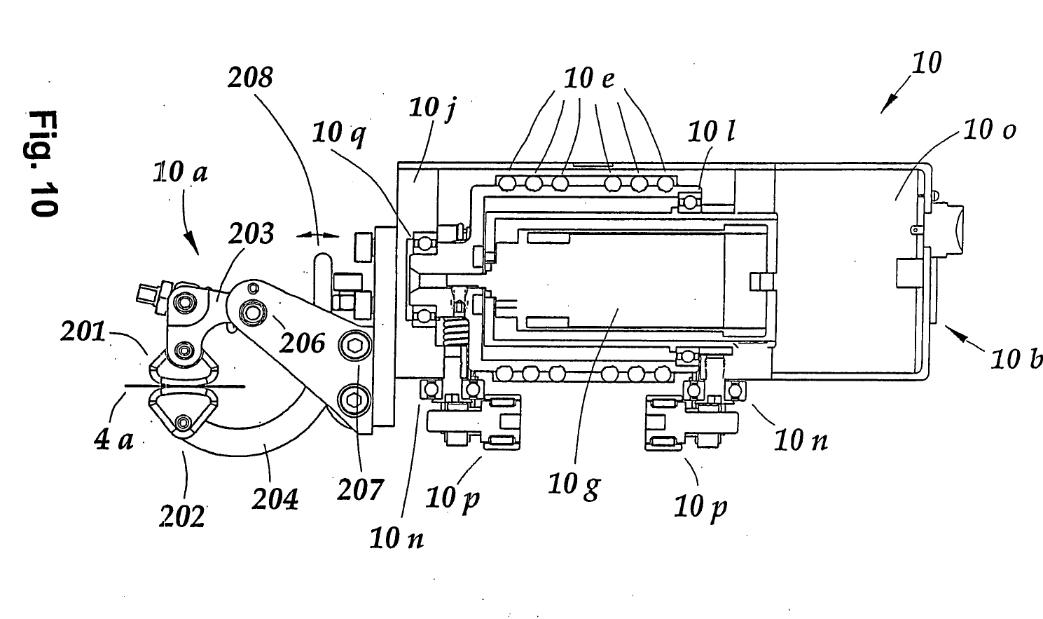

FIG. 12A shows a perspective view of the guide rail 15 used in an embodiment of the invention. FIG. 12B shows a cross sectional illustration of the guide rail illustrated on FIG. 12A. It is clear in particular that in the embodiment shown a current supply rail 17 is fixed next to the guide rail, which is bolted onto the holding devices 16 of the guide rail. The current supply rail serves to supply power to the drive motor of the film-drafting device, which moves on the guide rail. For this purpose conductor strips with sliding contacts are placed on the current supply rail. Preferably the drive motor can be driven via accumulators (as shown in FIGS. 9 and 10). The whole of the guide rail is seamlessly joined together from standard elements (straight sections, elbows, various radii and angles), in order to permit fast and economical adaptation to different types of machines.

In principle it is possible that the gripper and conveyor device 10 does not have its own drive but is moved along the guide rail by means of rope or chain systems known from the prior art.

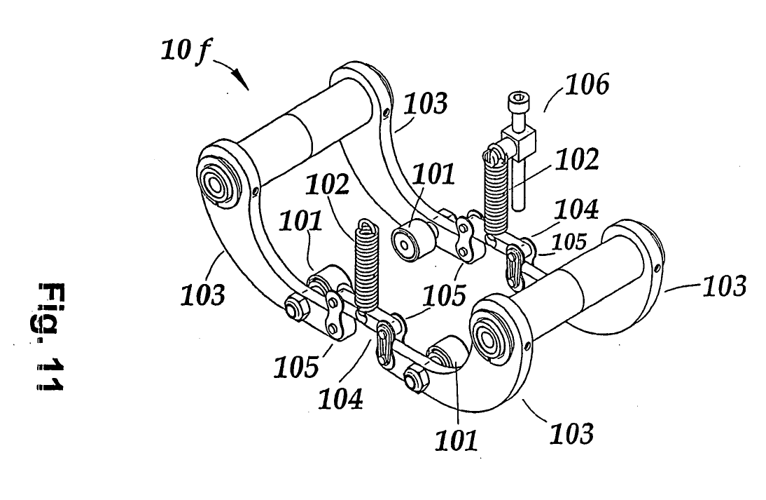

FIGS. 13A and 13B show two embodiments of prior art winding roller types 2. In the embodiment on FIG. 13 the film web is conveyed above the winding rollers 8 and 9 by means of the film-drafting device to a lower park position P. Furthermore the cutting arm 7, for cutting the film web, is arranged above the rollers. In contrast to this in the winding device on FIG. 13B the film is conveyed below the winding rollers 8 and 9 by means of the film-feeder device 10 to an upper park position P. Furthermore the cutting arm is arranged below the winding rollers 8 and 9.

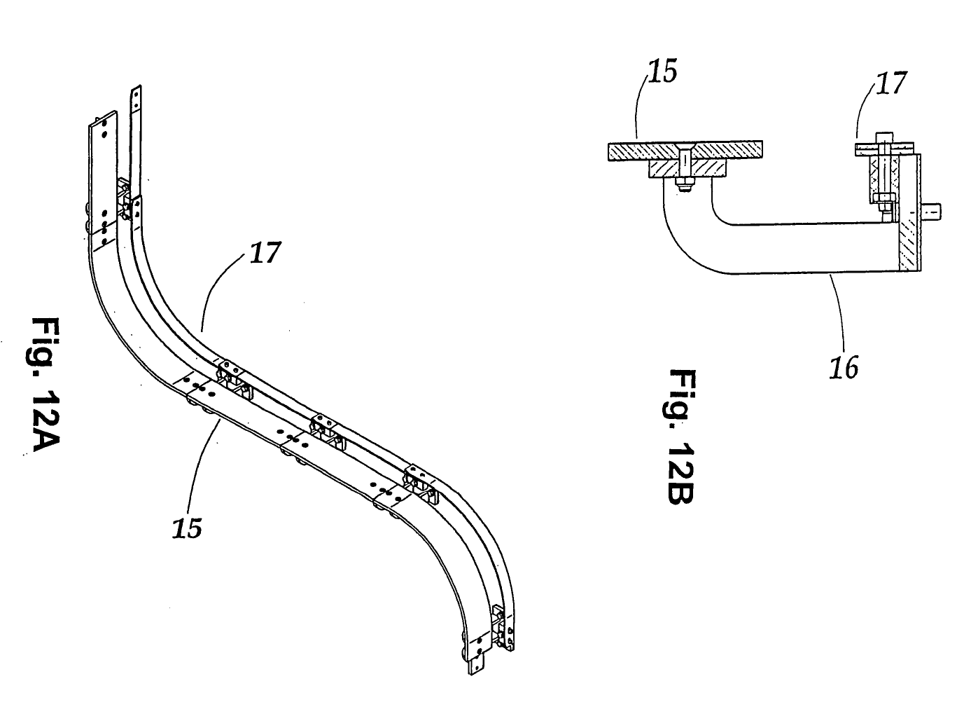

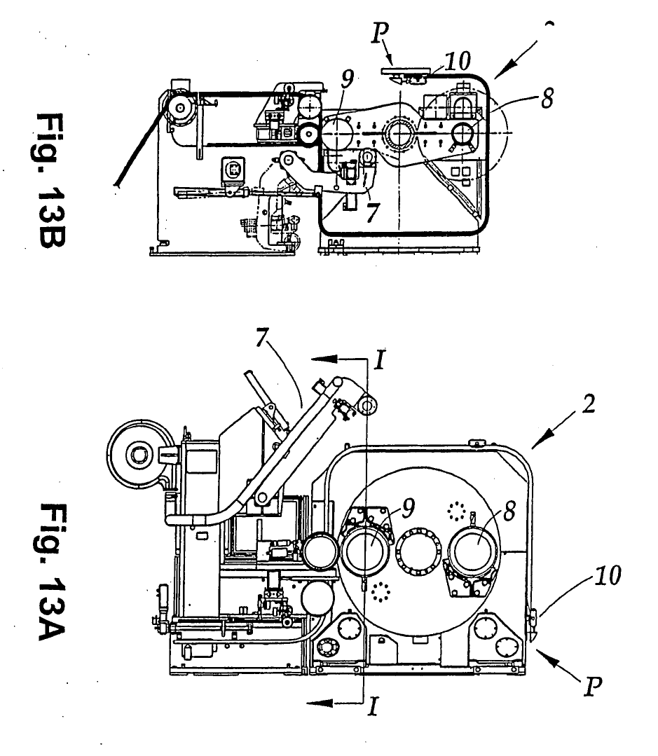

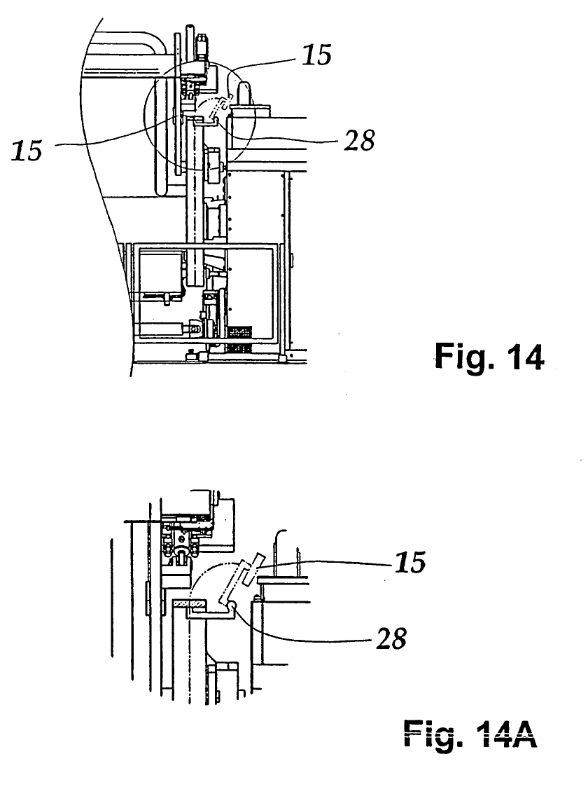

FIG. 14 shows a cutaway view along line I-I of FIG. 13A. Here it is particularly evident that part of the guide rail 15 is pivotably mounted on a pivot axis 18. The guide rail can be folded upwards via the pivot axis, as indicated by the imaginary lines on FIG. 14. Reason for pivoting is that the cutting arm 7 during the cutting operation has access to the film web, because access to the film web is normally prevented by the guide rail. The in- and out-swinging of the guide rail in this case can be automated via a corresponding control unit. An enlarged illustration of FIG. 14 for elucidation of the pivotable rail section is shown in the detailed illustration on FIG. 14A.

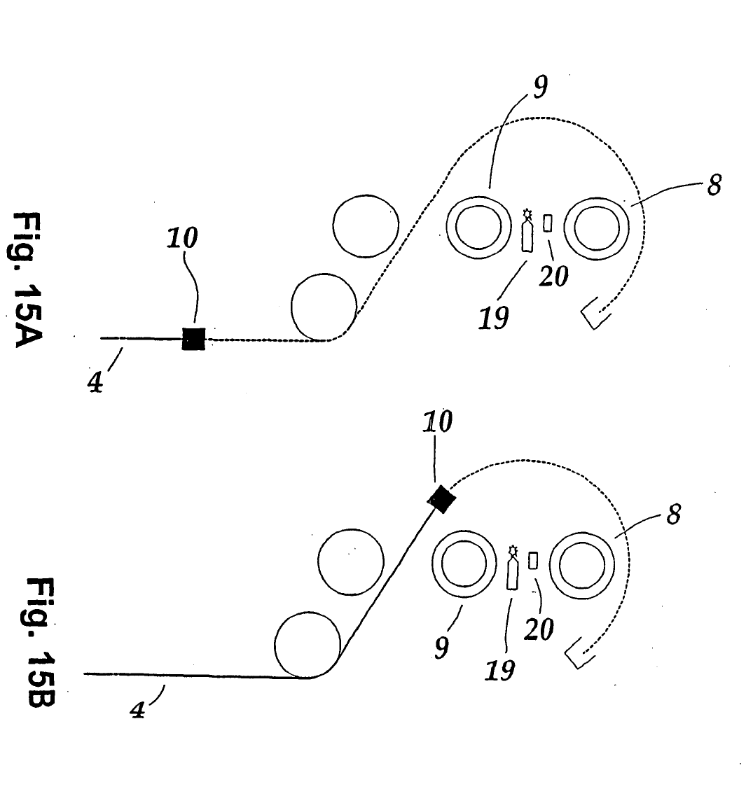

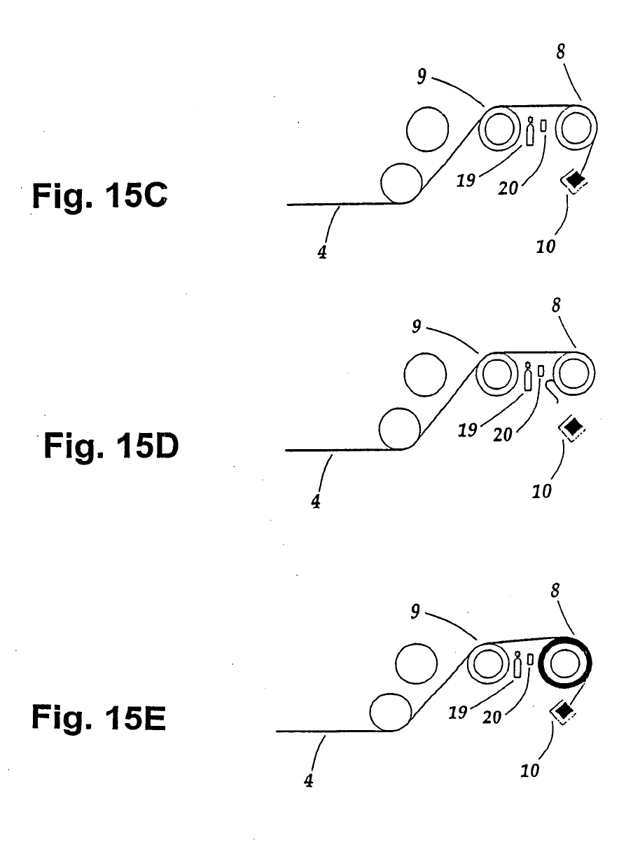

FIGS. 15A to 15E schematically show the sequence of the transfer process of the film web to the winding roller 8 of the winding device. In the drawings the distance of the gripper and conveyor device 10 still to be covered is indicated by dotted lines in each case. FIG. 15A shows the situation when the film-drafting device is moved straight into the winding device 2. It is particularly evident that, close to the scrap roller, a sensor 20 and a device for applying adhesive means 19 is located between winding rollers 8 and 9. The sensor 20 detects when the film web passes it and controls the spraying device 19 accordingly, as explained below. In FIG. 15B the conveyor device 10 is directly above the winding roller 9. The sensor up to then has still not detected any film. In FIG. 15C the film-drafting device 10 is finally in its park position P. The film marginal strip conveyed by the film-drafting device has finally come into contact with the top of the two winding rollers 8 and 9. The sensor 20 detects the presence of the film web and controls the spraying device 20, which applies the adhesive means to the film web. The adhesive means serves to glue the film web onto the winding roller 8. The adhesive means can be a liquid adhesive, adhesive bead or even water. Regarding the use of an adhesive a hot adhesive based on PP can come into consideration. The place where the adhesive is sprayed onto the film web can be adjusted in such a way that the optimum gluing effect is ensured when the point of contact on the winding roller 8 is reached. If water is used as adhesive means, in comparison to an adhesive, a larger spraying surface has to be provided, for which reason the spraying device 19 has several spray nozzles. After the spraying process has finished the film web is finally released by the gripper and conveyor device and due to the adhesive means the film web sticks to the winding roller 8, as shown on FIG. 15D. FIG. 15E finally shows a scenario, where winding takes place again on a previously used scrap roller.

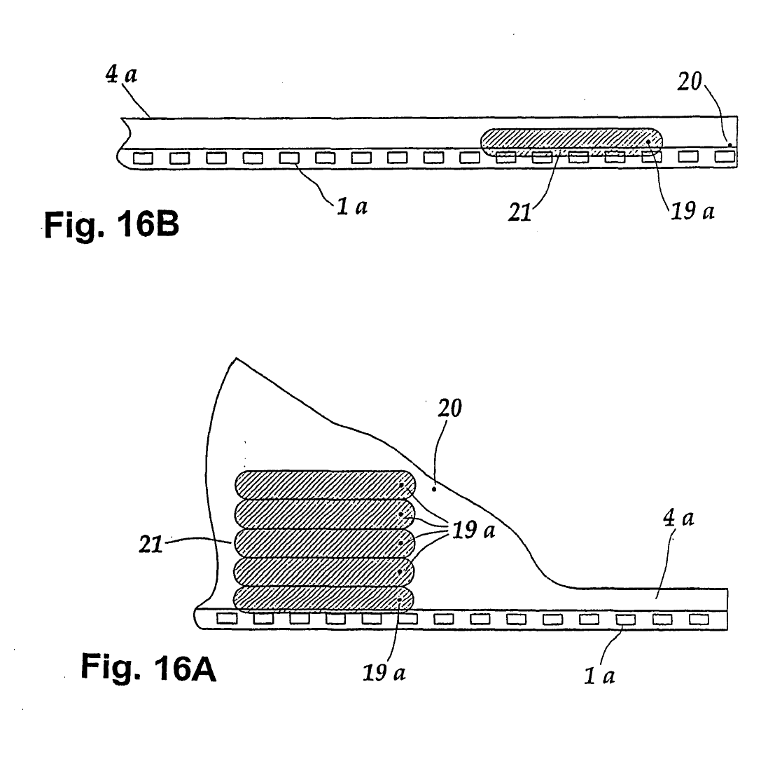

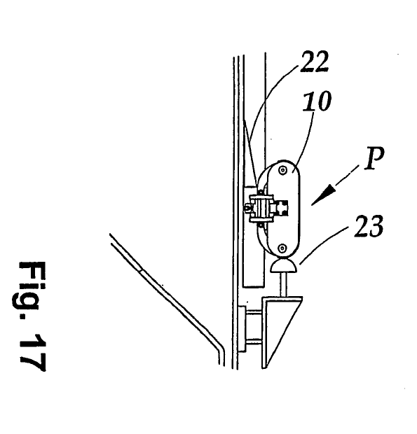

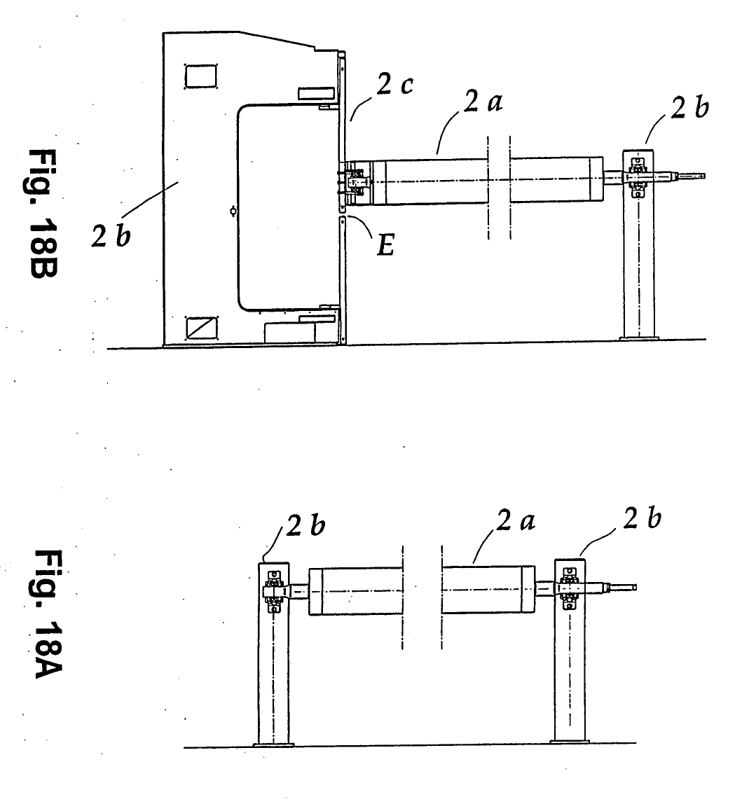

FIG. 16A shows a detailed view of the spraying device used in FIGS. 15A to 15E and the adherent areas with film web located over these. During the spraying process attention must be paid to exact synchronization of spraying with the operation of the film-drafting device.

FIG. 17 shows a detailed view of the film-drafting device 10 in the park position P on FIG. 13A. The film-drafting device in the park position comes up against a stopper 23. The film-drafting device is opened for example by an opening wedge 22, with which the articulated lever of the gripper of the film-drafting device is operated for example and opens the gripper. It is noted here that the guide rail must not necessarily end up in the position P. In particular it is also possible to design the guide rail as a closed circulating path so that the film-drafting device can move from the park position to the start position in the exit region of the handling device, without the driving direction having to be changed.

In principle a manual, semi-automatic or automatic transfer of the film web 4, conveyed through the system via the gripper and conveyor device can take place in the vicinity of the winding reel to the winding reel or a waste roller. Preferably the transfer takes place at least on a winding roller 8 of the winding device (3).

1. Process for processing a film web, which runs from a stretching apparatus, including:
cutting the film web in the longitudinal direction,
forming a marginal strip and a main film web reduced by the width of the marginal strip,
transferring the marginal strip to a movable gripper and conveyor device,
before, during and/or after transfer of the marginal strip to the movable gripper and conveyor device, separating a leading section of the marginal strip and separating the main film web, wherein separation takes place completely or partially by cutting and also possibly by tearing,
moving the gripper and conveyor device along one side of a roller arrangement,
threading the film web into the roller arrangement,
moving the gripper and conveyor device along one side of a winding device comprising at least one winding roller up to a release or end position, and
opening the gripper and conveyor device in the end position to release the marginal strip.

2. Process according to claim 1, wherein the cutting operation carried out in the film web in the longitudinal direction to produce a marginal strip is performed in a section of the exit region of the stretching apparatus, wherein the clips belonging to the stretching apparatus still firmly hold the film.

3. Process according to claim 1, wherein after the marginal strip has been cut, a leading section of the main film web is cut off, by a separation cut being made from the long-side first edge of the main film web bordering the marginal strip up into the proximity of the opposite long-side second edge of the main film web, and in that afterwards in the proximity of the second edge a further marginal strip is cut in the longitudinal direction of the film web, which is cut off before the film web is fed into the roller arrangement.

4. Process according to claim 3, wherein the further marginal strip is cut in a section of the exit region of the stretching apparatus, where the clips of the stretching apparatus are not yet opened.

5. Process according to claim 1, wherein the separation cut for separating the main film web takes place in such a manner that it is cut through or separated from a long-side first edge bordering the marginal strip of the main film web up to the opposite long-side edge of the main film web.

6. Process according to claim 5, wherein the separation cut for separating the main film web on the second edge of the main film web is performed on the so-called drive side in such a way that it ends between two adjacent clips, not yet opened, of the stretching apparatus.

7. Process according to claim 1, wherein the separation cut for separating a leading section of the main film web takes place at an acute angle to the pull direction of the film web.

8. Process according to claim 1, wherein cutting of the marginal strip and/or separation of the main film web take place automatically with a cutting device, which can be moved in a controlled way.

9. Process according to claim 1, wherein the transversal cutting of the marginal strip and/or separation of the main film web take place manually.

10. Process according to claim 1, wherein a leading part of the marginal strip is separated after or during transfer of the marginal strip to the gripper and conveyor device.

11. Process according to claim 1, wherein a section of the marginal strip is automatically transferred to a film-drafting device with an associated gripper and conveyor device, so that the marginal strip is fed into the roller arrangement.

12. Process according to claim 1, wherein the gripper and conveyor device is moved up to the exit of the stretching apparatus and there takes hold of the marginal strip automatically or after an activation signal has been sent.

13. Process according to claim 1, wherein the marginal strip and/or a leading lateral film web section are manually inserted into the gripper and conveyor device and fixed and held by closing the gripper and conveyor device.

14. Process according to claim 1, wherein the edge section and/or a leading film web section are transferred semi-automatically into the gripper and conveyor device, by the initially uncut film web being removed by means of a conveyor device from the danger area of the stretching apparatus and then transferred manually to the gripper and conveyor device after the marginal strip has been cut and a transversal cut has been carried out.

15. Process according to claim 1, wherein the film web, while the gripper and conveyor device is moved along the winding devices is sprayed with adhesive means, in particular adhesive and/or water, or this adhesive is applied to the winding reel or the waste roller.

16. Process according to claim 1, wherein the roller arrangements and the winding device are driven on a drive side and the gripper and conveyor device is moved on the side facing this.

17. Process according to claim 1, wherein the gripper and conveyor device after reaching the end position, is moved back to the handling device, in order to take hold of a new marginal strip.

18. Process according to claim 1, wherein the film web is transferred manually, semi-automatically or automatically to a winding reel or a waste roller for rolling the film web on the at least one winding roller of the winding device.

19. Device for processing a film web in particular running from a stretching apparatus, comprising:
at least one cutting device for cutting the film web in the longitudinal direction, forming a marginal strip and a main film web reduced by the width of the marginal strip,
the at least one cutting device being configured so that a leading section of the film web and of the main film web can be separated completely or partially from a following section of the film web, and
a movable gripper and conveyor device with a gripper located thereon, via which the marginal strip of the film web and/or a leading edge of the film web to be wound can be gripped at its boundary region, and via which the marginal strip and thus the film web to be wound are movable on the opposite side to the drive side of the roller arrangement along a rail arrangement as far as a release and/or end position, wherein the gripper located on the gripper and conveyor device in the release and/or end position can be opened to release the gripped edge, so that the film web can be wound onto a winding roller of a winding device.

20. Device according to claim 19, wherein the cutting device is arranged in the exit region of the stretching apparatus and/or is movable there.

21. Device according to claim 19, wherein the cutting device has a pivot axis, via which the cutting angle of a cutting means of the cutting device is adjustable related to the pull direction of the film web.

22. Device according to claim 21, wherein the cutting means comprises a rotary blade, preferably with an integrated drive.

23. Device according to claim 19, wherein the cutting device comprises a fixing arrangement, which stabilizes the film web during the cutting operation of the cutting device and prevents uncontrolled tearing of the film starting from the position of the cutting device at least beyond the fixing arrangement.

24. Device according to claim 23, wherein the fixing arrangement consists of at least one pair of rollers, through which by producing a contact pressure the film web to be cut is moved, before the film web reaches the cutting position, wherein preferably at least one roller of the pair of rollers can be driven.

25. Device according to claim 19, wherein the cutting device can be moved away over the film web, which at least in sections, is aligned at a sharp or acute angle to the pull direction of the film web.

26. Device according to claim 19, wherein the cutting device is arranged and/or can be moved so that the cutting operation takes place in a section of the stretching apparatus, where the clips are still closed or just open.

27. Device according to claim 19, wherein the cutting device can be positioned in such a manner that in operation it cuts a further marginal strip running in the longitudinal direction in the edge of the remaining film web opposite the first marginal strip

28. Device according to claim 19, wherein a transfer device is provided to transfer the marginal strip to the film-drafting device.

29. Device according to claim 28, wherein the transfer device comprises a wedging and/or a suction device for conveying the film web in a general horizontal direction.

30. Device according to claim 28, wherein the transfer device partially comprises a suction belt device, a single belt device or a double belt device arranged partially above and partially underneath the film and taking up the film in the centre sandwich-fashion, via which the film web can be conveyed further.

31. Device according to claim 28, wherein the transfer device consists of a belt feeder, which can be lifted via a jack device preferably in the form of a scissor jack for conveying the film web at least approximately up to the film plane and can be moved, preferably lowered, away from the film plane after the transfer has taken place.

32. Device according to claim 19, wherein the cutting device is downstream to the transfer device in the conveyor direction.

33. Device according to claim 19, wherein a closing device to close the gripper and conveyor device and/or a cutting unit to cut off a leading part of the marginal strip is provided at the position, where in operation the marginal strip is transferred to the film-drafting device.

34. Device according to claim 19, wherein the gripper and conveyor device comprises a carriage driven electrically and/or mechanically with one or more transport rollers, wherein the carriage can move on a guide rail, which extends from the exit region of the stretching apparatus along one side of the roller arrangement and one side of the winding device.

35. Device according to claim 34, wherein the guide rail is arranged belt-shaped, preferably has a rectangular cross section and comprises, seen from the side, straight and/or curved rail sections, wherein the transport rollers and/or sliding bearing mechanisms provided of the gripper and conveyor device, configured in the form of a carriage, rest on the opposite large bearing surfaces formed in this way and on the narrower front ends formed on the left and on the right, via which the carriage-like gripper and conveyor device is held captive and can be moved along the guide rail.

36. Device according to claim 34, wherein the carriage comprises a drive unit to drive at least one transport roller.

37. Device according to claim 34, wherein a current rail is arranged next to the guide rail to supply power to the drive unit.

38. Device according to claim 34, wherein a stationary driving device is provided, which is connected to the carriage, which is movable on the guide rail by a pulling device, so that the carriage can be moved along the guide rail.

39. Device according to claim 34, wherein at least one of the transport rollers has frictional engagement means or positive engagement means on its surface.

40. Device according to claim 34, wherein the carriage comprises a hugger device, with which the at least one transport roller is pressed against the guide rail.

41. Device according to claim 34, wherein a section of the guide rail can be moved or pivoted out from the remaining section of the guide rail and can be again moved or pivoted back, in particular within that region, where the cutting device is movable during the cutting operation of the film web.

42. Device according to claim 19, wherein an opening devices for automatic opening of the gripper located on the film-drafting device is arranged in the end position of the film-drafting device.

43. Device according to claim 19, wherein a spraying device is provided in the vicinity of the winding device, via which adhesive means triggered by a sensor and/or by the gripper and conveyor device reaching a certain position, can be sprayed onto the film web.

44. Device according to claim 43, wherein the spraying device is coupled with a detector or sensor facility, with which it can be recognized whether a film web is at any place in the winding device.

45. Device for the production of wound film reels, comprising:
a stretching apparatus for producing plastic film,
a pull roll device in the form of a roller arrangement,
a winding device for winding the film web exiting the roller arrangement onto a winding roller,
at least one cutting device for cutting the film web in the longitudinal direction, forming a marginal strip and a main film web reduced by the width of the marginal strip,
the at least one cutting device being configured so that a leading section of the film web and of the main film web can be separated completely or partially from a following section of the film web, and
a movable gripper and conveyor device with a gripper located thereon, via which the marginal strip of the film web and/or a leading edge of the film web to be wound can be gripped at its boundary region, and via which the marginal strip and thus the film web to be wound are movable on the opposite side to the drive side of the roller arrangement along a rail arrangement as far as a release and/or end position, wherein the gripper located on the gripper and conveyor device in the release and/or end position can be opened to release the gripped edge, so that the film web can be wound onto a winding roller of a winding device.
